(19) United States
(12) Patent Application Publication
(10) Pub. No.: US 2021/0121900 A1
(43) Pub. Date: Apr. 29, 2021

(54) Material Clearing System For An Agricultural Machine

(71) Applicant: CNH Industrial America LLC, New Holland, PA (US)

(72) Inventor: William A. Roach, Lake Lillian, MN (US)

(21) Appl. No.: 16/661,179

(22) Filed: Oct. 23, 2019

(51) Int. Cl. B05B 7/24; A01M 7/00; B05B 9/04

(52) U.S. Cl. CPC B05B 7/2486; B05B 9/0403; A01M 7/0071

(57) ABSTRACT

The invention provides a material clearing or cleaning system which can be installed on an agricultural machine to spray off, blow off or otherwise clear off agricultural product, dust, debris and/or other material from the machine. The material clearing system can comprise a piping, tubing or fluid conduits with installed nozzles which can be customized to focus a cleaning fluid, such as air or water delivered under compression, onto targeted areas of likely build-up on the machine, to clear such excess material and increase the life of the equipment. Nozzles could be fitted anywhere on the piping, for example, by piercing a nozzle into the piping in a given direction. Nozzles could also comprise goose necks for directing the fluid in various directions by reshaping the goose neck.

### FIELD OF THE INVENTION

This invention generally relates to self-propelled agricultural applicators, and more particularly to a material clearing system for such applicators having a fluid supply line routed along the applicator and multiple material clearing nozzles for spraying a material clearing fluid onto the applicator.

### BACKGROUND OF THE INVENTION

Agricultural machines, such as self-propelled agricultural product applicators, are often used to spread agricultural product, such as chemicals and fertilizers, in the treatment of agricultural fields. During such applications, it is not uncommon for such product, in addition to dust, debris and/or other material, to collect on the machine itself. The undesirable collection of such material can be corrosive to the machine and/or could inhibit proper operation of the machine over time. This is specifically concerning with respect to certain component and/or areas of the machine that may be more sensitive, such as the driveline system, various manifolds, weldments, and the like. It is therefore desirable to provide an agricultural machine capable of spreading product in the treatment of agricultural fields while minimizing the undesirable collection of agricultural product, dust, debris and/or other material, on areas of the machine itself.

### BRIEF SUMMARY OF THE INVENTION

The invention provides a material clearing or cleaning system which can be installed on an agricultural machine to spray off, blow off or otherwise clear off agricultural product, dust, debris and/or other material from the machine. The material clearing system can comprise a piping, tubing or fluid conduits with installed nozzles which can be customized to focus a cleaning fluid, such as air or water delivered under compression, onto targeted areas of likely build-up on the machine, to clear such excess material and increase the life of the equipment. Nozzles could be fitted anywhere on the piping, for example, by piercing a nozzle into the piping in a given direction. Nozzles could also comprise goose necks for directing the fluid in various directions by reshaping the goose neck. If air is used, the material clearing system could be powered from shop air and/or on-board vehicle compressed air. If water is used, the system could be powered by a local water supply, such as via a garden hose, and/or an on-board rinse take.

Specifically, then, one aspect of the invention can comprise a material clearing system for an agricultural machine. The material clearing system can include: a frame supported by ground engaging wheels; a sprayer arrangement supported by the frame, the sprayer arrangement including agricultural product delivery nozzles for spreading agricultural product onto a field; and a fluid supply line routed along the agricultural machine, the fluid supply line including material clearing nozzles for spraying a material clearing fluid onto the agricultural machine.

Another aspect of the invention can comprise a method for clearing material from an agricultural machine. The method can include: supporting a sprayer arrangement by a frame and ground engaging wheels, the sprayer arrangement including agricultural product delivery nozzles for spreading agricultural product onto a field; and routing a fluid supply line along the agricultural machine, the fluid supply line including material clearing nozzles for spraying a material clearing fluid onto the agricultural machine.

Other aspects, objects and advantages of the invention will be apparent from the following detailed description and accompanying drawings of exemplary embodiments of the invention.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an isometric view of a self-propelled agricultural product applicator having a material clearing system for clearing agricultural product, dust, debris and/or other material from the machine according to an aspect of the invention;

FIG. 2 is a side view of the agricultural product applicator of FIG. 1;

FIG. 3 is a block diagram exemplifying the material clearing system routed on the agricultural product applicator of FIGS. 1 and 2 according to an aspect of the invention;

FIG. 4 is a diagram illustrating an exemplar material clearing nozzle attached to a fluid supply line according to one aspect of the invention;

FIG. 5 is a diagram illustrating an exemplar material clearing nozzle attached to a fluid supply line according to another aspect of the invention; and

FIG. 6 is a block diagram illustrating fluid flow of a material clearing system according to an aspect of the invention;

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

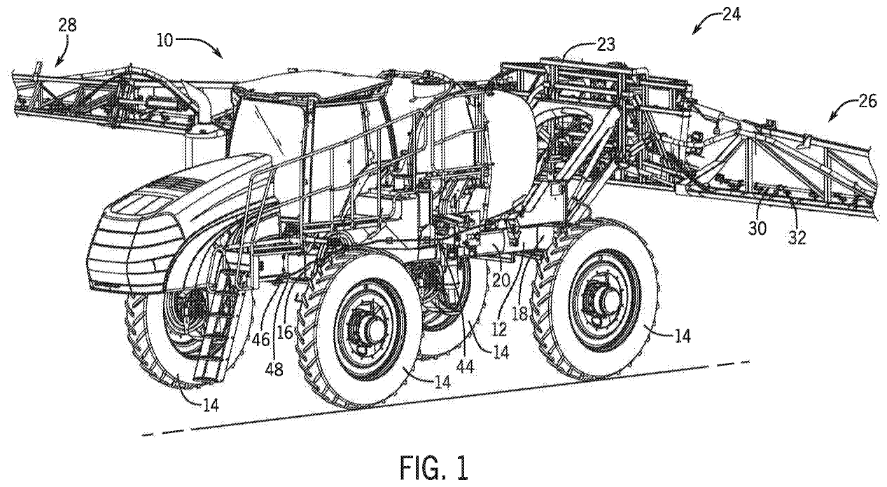

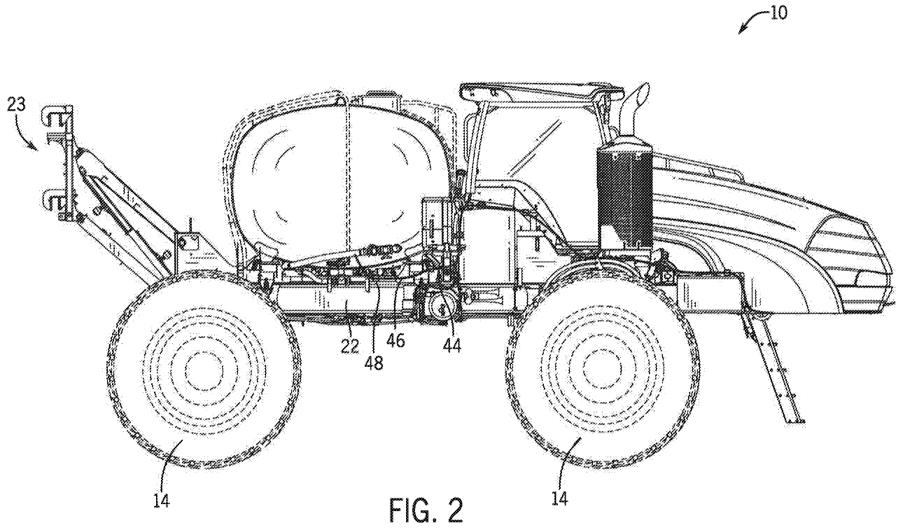

FIGS. 1 and 2 show isometric and side views, respectively, of an exemplary embodiment of a self-propelled agricultural product applicator 10 having a material clearing system for clearing agricultural product, dust, debris and/or other material from the machine according to an aspect of the invention. The applicator 10 includes a frame 12 supported by ground engaging wheels 14 that are operatively connected to the frame 12, such as via front and rear frame members or tubes 16, 18 and left and right frame members or tubes 20, 22, respectively, joined at intersections or weldments. The applicator 10 is shown by way of example as having a center section 23 carrying a sprayer arrangement 24. The sprayer arrangement 24 could comprise, for example, a spray boom having left and right boom sections 26, 28, with each boom section supporting product boom tubes 30 or conduits terminating at spreading outlets 32, or agricultural product delivery nozzles, for spreading agricultural product such as chemicals and/or fertilizers to the ground. In another aspect, the applicator 10 could be configured for carrying a dry product spreader box.

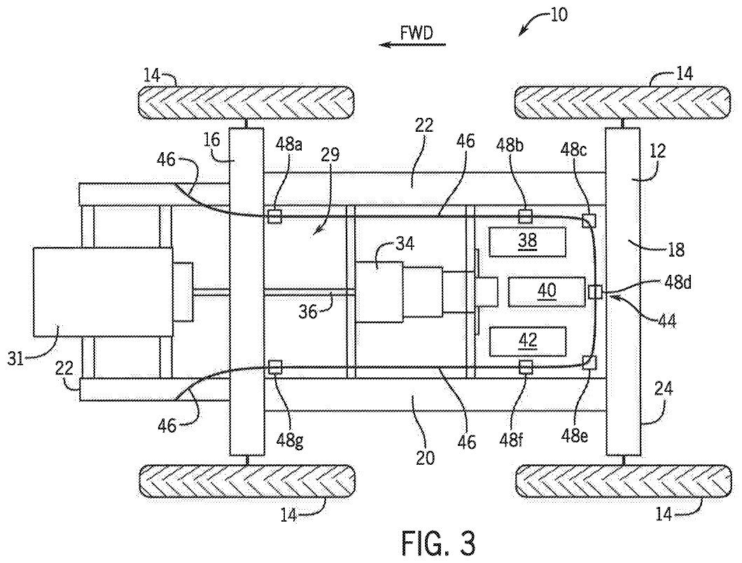

As shown in a block diagram in FIG. 3, the front and rear frame members or tubes 16, 18 can extend from a left side to a right side of the frame 12, and the left and right frame members or tubes 20, 22 can extend from a front end to a rear end of the frame 12, with the frame members intersecting at four points forming the intersections or weldments. The frame 12 can be configured to structurally support multiple components of the applicator 10, such as a drive line arrangement 29 including an engine 31 connected to a remotely mounted driven device, such as a pump arrangement 34 connected via a driveshaft 36, a hydraulic manifold 38 for distributing hydraulic fluid in the system for propulsion from the pump arrangement 34 to the wheels 14 and/or for steering the wheels 14, an electric manifold 40 for controlling electronic valves such as solenoids in the distribution of hydraulic fluid for the propulsion and/or steering systems, and/or a pneumatic manifold 42 for controlling compressed air in the system, such as for suspension with respect to the wheels 14, on board compressors and the like.

Ira accordance with an aspect of the invention, a material clearing system 44 or cleaning system can be installed on the applicator 10 to prevent the undesirable collection and build-up of agricultural product, dust, debris and/or other material on specific components and/or areas of the applicator 10. The material clearing system 44 could comprise a fluid supply line 46, such as piping, tubing or fluid conduits, routed along the applicator 10. The fluid supply line 46 can include multiple, customizable material clearing nozzles 48 installed thereon for focusing and spraying a material clearing fluid onto select areas of likely build-up of material on the applicator 10 to clear such excess material and increase the life of the equipment. The material clearing fluid could comprise, for example, air or water delivered under compression. The fluid supply line 46 could be selectively routed or run through areas of the applicator 10 as desired by the user with retention of the fluid supply line 46 to the applicator 10. The fluid supply line 46 could be routed in one or more continuous lines underneath and/or interior to the applicator 10.

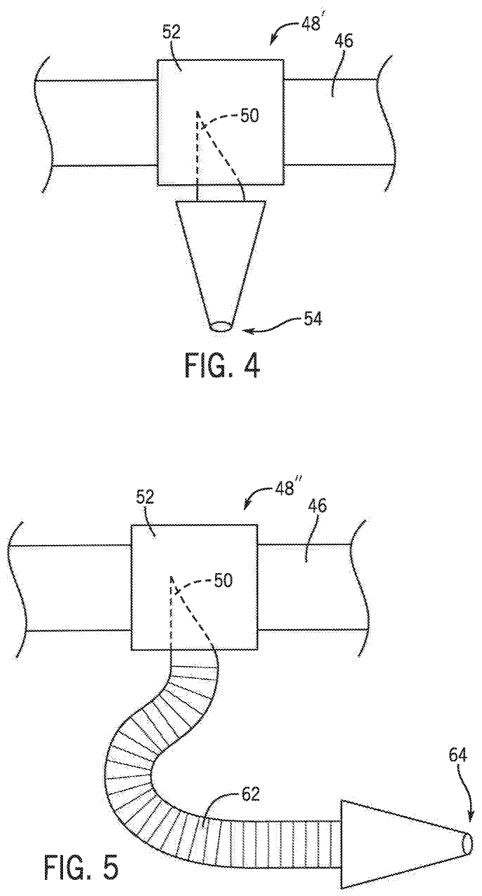

The material clearing nozzles 48 could be fitted anywhere on the fluid supply line 46 as desired. With additional reference to FIG. 4, in one aspect, one or more material clearing nozzles 48′ could be fitted to the fluid supply line 46 by a piercing end 50 of the material clearing nozzle 48′ penetrating the fluid supply line 46 with retention thereto by a clamp 52. That is, the piercing end 50 of the material clearing nozzles 48′ is configured to pierce into the fluid supply line 46 when installed on the fluid supply line. The material clearing nozzle 48′ can be selectively pierced by a user into the fluid supply line 46 with an outlet end 54 oriented in direction of likely build-up of material for clearing such build-up.

With additional reference to FIG. 5, in another aspect, one or more material clearing nozzles 48″ could include a goose neck 62 for directing the fluid in various directions by reshaping the goose neck. That is, the goose neck 62 of the material clearing nozzles 48″ is configured to direct the nozzle in multiple directions when adjusted, and maintain a given direction when at rest, with resiliency. The goose neck 62 could maintain a shape with resiliency so that the material clearing nozzle 48″ could be selectively oriented by a user with an outlet end 64 oriented in in a direction of likely build-up of material for clearing such build-up and maintaining such direction. It should be appreciated that various aspects of the aforementioned nozzles could be combined in different ways within the scope of the invention.

Accordingly, the material clearing nozzle 48 can be installed on the fluid supply line 46 and customized to focus the cleaning fluid onto targeted areas of likely build-up on the applicator 10 to clear such excess material. Referring again to FIG. 3, by way of example, underneath and/or interior to the applicator 10, a first material clearing nozzle 48a could be directed to a weldment between the front and right frame members 16, 22; a second material clearing nozzle 48b could be directed to the hydraulic manifold 38; a third material clearing nozzle 48c could be directed to a weldment between the rear and right frame members 18, 22; a fourth material clearing nozzle 48d could be directed to the electric manifold 40; a fifth material clearing nozzle 48e could be directed to a weldment between the rear and left frame members 18, 20; a sixth material clearing nozzle 48f could be directed to the pneumatic manifold 42; and a seventh material clearing nozzle 48g could be directed to a weldment between the front and left frame members 16, 20.

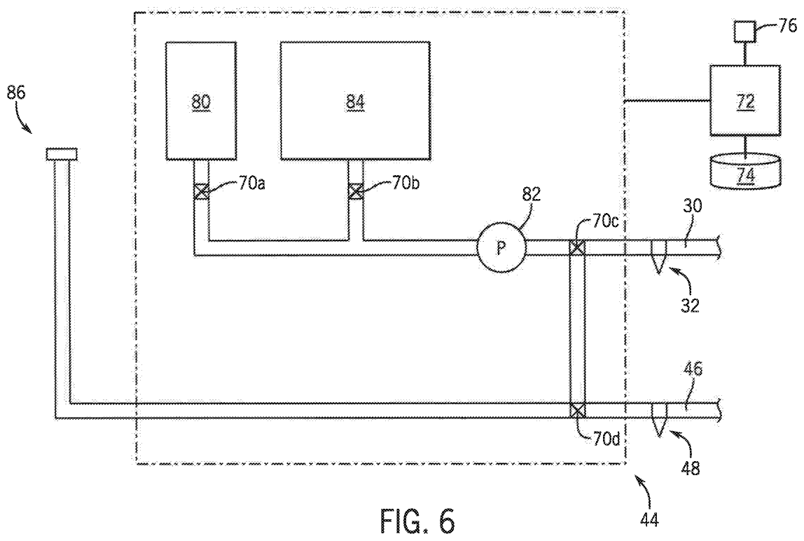

Referring now to FIG. 6, a block diagram illustrating an exemplar fluid flow of a material clearing system 44 is provided according to an aspect of the invention. The material clearing system 44 can include a valving arrangement comprising one or more multi-way valves 70, such as valves 70a-70d. The valving arrangement could be controlled by a processor 72 executing a program stored in a non-transient medium 74. In one mode of operation, the valving arrangement can be controlled by the processor 72 to direct material clearing fluid from a material clearing unit 80, which could also comprise a pump 82, to the material clearing nozzles 48. The material clearing fluid could be water, and the material clearing unit 80 could be a rinse tank. Moreover, such material clearing unit 80 could be in line with an agricultural product tank 84 for selectively delivering the material clear fluid or the agricultural product to the spreading outlets 32. Alternatively, the material clearing fluid could be air, and the material clearing unit 80 could be an air compressor onboard the applicator 10. In another mode of operation, the valving arrangement can be controlled by the processor 72 to block material clearing fluid from reaching the material clearing nozzles 48.

In yet another mode of operation, the valving arrangement could be configured to direct material clearing fluid from a port 86 configured to receive the material clearing fluid to the material clearing nozzles 48. If air is used, the material clearing system could be powered from shop air and/or on-board vehicle compressed air. If water is used, the system could be powered by a local water supply, such as via a garden hose, and/or an on-board rinse take. The material clearing fluid could be water, and the port 86 could receive the water from a local water supply, such as via a garden hose. Alternatively, the material clearing fluid could be air, and the port 86 could receive the air from a local air compressor. In yet a further mode of operation, the valving arrangement can be controlled by the processor 72 to block material clearing fluid from port 86 from reaching the material clearing nozzles 48.

The processor 72 can execute the program to control one or more of the aforementioned modes of operation by command from a user. For example, a user could select a mode of operation from an input source 76, and the processor 72 can receive such selection to activate and/or deactivate flow of material clearing fluid in the various manners described.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A material clearing system for an agricultural machine, comprising:
a frame supported by a plurality of ground engaging wheels;
a sprayer arrangement supported by the frame, the sprayer arrangement comprising a plurality of agricultural product delivery nozzles for spreading agricultural product onto a field; and
a fluid supply line routed along the agricultural machine, the fluid supply line comprising a plurality of material clearing nozzles for spraying a material clearing fluid onto the agricultural machine.

2. The material clearing system of claim 1, further comprising a hydraulic manifold for distributing hydraulic fluid for propulsion or steering of the agricultural machine, wherein a material clearing nozzle of the plurality of material clearing nozzles is directed to the hydraulic manifold.

3. The material clearing system of claim 1, further comprising an electric manifold for controlling electronic valves for propulsion or steering of the agricultural machine, wherein a material clearing nozzle of the plurality of material clearing nozzles is directed to the electric manifold.

4. The material clearing system of claim 1, further comprising a pneumatic manifold for controlling compressed for suspension of the agricultural machine, wherein a material clearing nozzle of the plurality of material clearing nozzles is directed to the pneumatic manifold.

5. The material clearing system of claim 1, wherein the frame comprises front and rear frame members, each extending from a left side to a right side of the frame, and left and right frame members, each extending from a front side to a rear side of the frame, wherein a material clearing nozzle of the plurality of material clearing nozzles is directed to a weldment between the front and left frame members, a weldment between the front and right frame members, a weldment between the rear and left frame members, or a weldment between the rear and right frame members.

6. The material clearing system of claim 1, wherein a material clearing nozzle of the plurality of material clearing nozzles is configured to pierce into the fluid supply line when installed on the fluid supply line.

7. The material clearing system of claim 1, wherein a material clearing nozzle of the plurality of material clearing nozzles comprises a neck configured to direct the nozzle in a plurality of directions and maintain a given direction of the plurality of directions with resiliency.

8. The material clearing system of claim 1, wherein the fluid supply line is configured to pump air through the plurality of material clearing nozzles.

9. The material clearing system of claim 8, further comprising an air compressor and a valving arrangement, wherein the valving arrangement is configured to direct air from the air compressor to the plurality of material clearing nozzles in a first mode of operation and block air from the air compressor to the plurality of material clearing nozzles in a second mode of operation.

10. The material clearing system of claim 8, further comprising a port configured to receive air and a valving arrangement, wherein the valving arrangement is configured to block the port in a first mode of operation and direct air from the port to the plurality of material clearing nozzles in a second mode of operation.

11. The material clearing system of claim 1, wherein the fluid supply line is configured to pump water through the plurality of material clearing nozzles.

12. The material clearing system of claim 11, further comprising a rinse tank and a valving arrangement, wherein the valving arrangement is configured to direct water from the rinse tank to the plurality of agricultural product delivery nozzles in a first mode of operation and direct water from the rinse tank to the plurality of material clearing nozzles in a second mode of operation.

13. The material clearing system of claim 11, further comprising a port configured to receive water and a valving arrangement, wherein the valving arrangement is configured to block the port in a first mode of operation and direct water from the port to the plurality of material clearing nozzles in a second mode of operation.

14. The material clearing system of claim 1, further comprising an input source and a processor executing a program stored in a non-transient medium to receive a selection from the input source and activate a flow of material clearing fluid in the fluid supply line following the selection.

15. A method for clearing material from an agricultural machine, comprising:
supporting a sprayer arrangement by a frame and a plurality of ground engaging wheels, the sprayer arrangement comprising a plurality of agricultural product delivery nozzles for spreading agricultural product onto a field; and
routing a fluid supply line along the agricultural machine, the fluid supply line comprising a plurality of material clearing nozzles for spraying a material clearing fluid onto the agricultural machine.

16. The method of claim 15, further comprising directing a material clearing nozzle of the plurality of material clearing nozzles to a hydraulic manifold for distributing hydraulic fluid for propulsion or steering of the agricultural machine.

17. The method of claim 15, further comprising directing a material clearing nozzle of the plurality of material clearing nozzles to an electric manifold for controlling electronic valves for propulsion or steering of the agricultural machine.

18. The method of claim 15, further comprising directing a material clearing nozzle of the plurality of material clearing nozzles to a pneumatic manifold for controlling compressed for suspension of the agricultural machine.

19. The method of claim 15, further comprising directing a material clearing nozzle of the plurality of material clearing nozzles to a weldment between members of the frame.

20. A material clearing system for a self-propelled agricultural applicator, the material clearing system comprising:
a frame supported by a plurality of ground engaging wheels;
a sprayer arrangement supported by the frame, the sprayer arrangement comprising a plurality of agricultural product delivery nozzles for spreading agricultural product onto a field;
a fluid supply line routed along the agricultural machine, the fluid supply line comprising a plurality of material clearing nozzles for spraying a material clearing fluid onto the agricultural machine; and
a hydraulic manifold for distributing hydraulic fluid for propulsion or steering of the agricultural machine, wherein a material clearing nozzle of the plurality of material clearing nozzles is directed to the hydraulic manifold.
